(19) United States
(12) Patent Application Publication
(10) Pub. No.: US 2025/0011193 A1
(43) Pub. Date: Jan. 9, 2025

(54) PARTICLES CONTAINING POLLUTANT-CAPTURING MICELLES AND RELATED METHODS

(71) Applicant: Massachusetts Institute of Technology, Cambridge, MA (US)

(72) Inventors: Patrick Seamus Doyle, Sudbury, MA (US); Devashish Gokhale, Cambridge, MA (US)

(73) Assignee: Massachusetts Institute of Technology, Cambridge, MA (US)

(21) Appl. No.: 18/707,798

(22) PCT Filed: Nov. 9, 2021
(86) PCT No.: PCT/US2021/058536

§ 371 Date: May 6, 2024

(51) Int. Cl. C02F 1/28

(52) U.S. Cl. CPC C02F 1/288; C02F 1/285; C02F 2303/16; C02F 2305/04

(57) ABSTRACT

Articles, compositions, and methods describing particles comprising micelles are generally described. In some embodiments, the micelles are configured to absorb pollutants from water and subsequently release the pollutants to a non-aqueous environment.

### TECHNICAL FIELD

Polymeric microparticles containing pollutant-capturing micelles and related methods are generally described.

### BACKGROUND

Pollutants, such as micropollutants, which can occur at low concentrations in the environment, are ubiquitous, hazardous, and difficult to remove from water using certain existing systems and methods. Micropollutants are ubiquitous and include industrial organic solvents, intermediates and lubricants, industrial surfactants, household products such as detergents and disinfectants, antibiotics and other medications, certain heavy metals, food additives and flavoring agents, and nanomaterials. Many micropollutants can have significant adverse effects on the ecosystem even in low concentrations, which has made these pollutants a problem of concern. Some existing systems and methods eliminate micropollutants using similar technologies developed for the elimination of macropollutants, such as activated carbon adsorption, ozone or peroxide oxidation, and photodegradation. Though some pharmaceuticals may be removed through biological treatment and photodegradation, the elimination of other micropollutants in wastewater treatment plants remains highly variable and is usually poor. Accordingly, new articles and methods for removing micropollutants are needed.

### SUMMARY

Articles, compositions, and methods describing polymeric microparticles comprising micelles are generally described. In some embodiments, the micelles are configured to absorb pollutants (e.g., hydrophobic pollutants) within a source of water. The subject matter of the present disclosure involves, in some cases, interrelated products, alternative solutions to a particular problem, and/or a plurality of different uses of one or more systems and/or articles.

In one aspect, a composition comprising a monomer and a plurality of micelles, wherein each micelle of the plurality of micelles comprises a hydrophilic shell and a hydrophobic core wherein the micelles are configured to absorb and/or release a hydrophobic molecule is described.

In another aspect, a plurality of particles is described, each microparticle comprising a polymer and a plurality of micelles linked to the polymer, wherein at least a portion of the microparticles is configured to absorb and/or release a pollutant.

In another aspect, a method for removing pollutants from a source of water is described, the method comprising exposing the source of water to a plurality of microparticles comprising a polymer and a plurality of micelles linked to the polymer, wherein each of the micelles of the plurality of micelles comprises a hydrophilic shell and a hydrophobic core; capturing pollutants at least partially within the plurality of micelles; and removing the microparticles from the source of water.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is schematic illustration of a microfluidic system for forming monomer and polymeric compositions into microparticles, according to some embodiments;

FIG. 1B schematically illustrations the process of forming microparticles using a monomer solution comprising monomer and micelles, according to some embodiments;

FIGS. 2A-2B are cross-sectional schematic diagrams of microparticles without and with crosslinking agents, respectively, according to some embodiments;

FIG. 2C is a cross-sectional side perspective of a source of water contained in a container, the source of water comprising micropollutants, according to some embodiments;

FIG. 2D schematically illustrates the process of absorbing micropollutants with microparticles comprising micelles, according to some embodiments;

FIG. 3 is a schematic diagram showing the capture of a hydrophobic micropollutant by micelles within a polymer, according to some embodiments;

FIG. 4A is a schematic illustration of structural templates of the constituent surfactants and crosslinking agent, according to some embodiments;

FIG. 4B is a schematic illustration of the chain-growth polymerization of monomers to produce crosslinked bond network, according to some embodiments;

FIG. 4C schematically illustrates how surfactants form micelles in the monomer mix and are incorporated in this form into the crosslinked gel, according to some embodiments;

FIGS. 4D-4E are schematic illustrations of an off-the-shelf micro-cross used to process the monomer solution into droplets, which are then UV-polymerized into particles, according to some embodiments;

FIG. 4F shows a schematic of the micro-cross and microparticle synthesis process, according to some embodiments;

FIG. 5 shows the conversion and incorporation of monomers in hydrogel microparticles: H-NMR analysis with FIG. 5A showing the hydrolysis of hydrogels into soluble components for H-NMR, FIG. 5B showing spectra for the hydrolyzed monomer mixture and for hydrogels hydrolyzed immediately after polymerization with any oligomers are removed through 7 days of washing and cleaned hydrogels are hydrolyzed and analyzed to obtain spectrum, shown in FIG. 5C, which also contains acetone as an internal standard, according to some embodiments;

FIG. 6A-6C show equilibrium isotherms for the uptake of 2-napthol dissolved in water and 90% ethanol, and the isotherms are shown for three surfactants: (A) S80TA, (B) B25MA, and (C) F127DA, each with various concentrations, according to some embodiments;

FIG. 7A shows the pollutant removal kinetics relative to the concentration of 2-naphthol in the supernatant over time when removed using hydrogel microparticles containing B25MA, with uptake by activated carbon shown using asterisks, according to some embodiments;

FIG. 7B shows the pollutant removal kinetics relative to the concentration of 2-naphthol in the supernatant over time when removed using hydrogel microparticles containing F127DA, with uptake by activated carbon shown using asterisks, according to some embodiments;

FIG. 7C shows the pollutant removal kinetics relative to the concentration of 2-naphthol in the supernatant over time when removed using hydrogel microparticles containing S80TA, with uptake by activated carbon shown using asterisks, according to some embodiments;

FIG. 7D shows comparisons of profiles for four surfactants at the same concentration (5%), according to some embodiments;

FIGS. 7E-7F show mass transfer coefficients corresponding to the hydrogel microparticles and a commercial activated carbon (Brita AC; black asterisks), according to some embodiments; and

FIG. 8 shows the effect of preparing F127DA monomer solutions in ethanol-water mixtures to boost surfactant incorporation, (A) Phase diagram showing the sol-gel transition in F127DA systems with 10% PEGDA, 5% PI dissolved in ethanol-water mixtures, and the domain in which surface tension allows good quality droplets to form, (B) The equilibrium isotherms corresponding to the 40% F127DA in 40% ethanol system, compared to F127DA systems in water, (C) Kinetics and (D) mass transfer coefficients showing the same comparison, and also comparing performance with a commercial activated carbon (Brita AC), according to some embodiments.

### DETAILED DESCRIPTION

The present disclosure describes articles, compositions, and methods including micelles that can be configured to absorb pollutants (e.g., micropollutants) from a water source. As micropollutants can be a source of contamination in water systems, there has been some work towards removing these pollutants from water. While certain existing systems and methods have some effectiveness at removing some pharmaceutical pollutants from a source of water through biological treatment or photodegradation, the elimination of other micropollutants in water systems can be highly variable and is usually low. However, it has been recognized and discovered by this disclosure that polymeric absorbents containing immobilized micelles may be used to remove micropollutants (e.g., hydrophobic micropollutants) from water. A monomer having a hydrophilic moiety (e.g., polyethylene oxide, PEO) can be attached or chemically linked to a surfactant, which may self-assemble (e.g., in water) into a micelle. The monomer can then be polymerized to form a polymeric composition containing a micelle within the polymer composition. In some cases, the composition may also contain a crosslinking agent to facilitate polymerization. These micelles may contain a hydrophilic shell (e.g., attached to the hydrophilic backbone of the polymer) and hydrophobic core, which may selectively absorb hydrophobic micropollutants. In this way, the polymer composition can absorb micropollutants when placed in water.

The terms “hydrophobic” and “hydrophilic” are used generally according to their ordinary meanings in the art, although it will be understood that these terms are generally understood to be relative, not absolute, and in some embodiments described herein, these terms are indeed relative. For example, those of ordinary skill in the art understand that a micelle as described herein comprising a hydrophilic shell and a hydrophobic core means a micelle constructed of molecules having portions that have different affinities to, for example, water or oil sufficient to allow them to self-assemble as micelles. The hydrophilic (generally but not always lipophobic) shells and hydrophobic (generally but not always lipophilic) cores need not have any specific level of hydrophilicity or hydrophobicity. Similarly, the hydrophilic cores need not have any specific level of water repellency but, in many embodiments, will have a level of lipophilicity sufficient to absorb a hydrophobic (or lipophilic) pollutant as describe herein. In various embodiments, as different pollutants having different degrees of hydrophobicity or lipophilicity are desirably taken up by the micelles via absorption, the hydrophobicity or lipophilicity of portions of the molecules that make up the micelle (and contribute to their cores) can be adjusted to levels that will allow the micelles to function in absorbing and/or releasing pollutants. This does not necessarily mean that the micelle should be constructed so that its core has a hydrophobicity or lipophilicity as closely matched as possible to the hydrophobicity or lipophilicity of the pollutant desirably taken up. In some cases, the micelle may be as closely matched as possible to the pollutant in order to increase absorption of the pollutant. But in some cases matching too closely can impede pollutant removal from the micelles upon regeneration. With these, and other considerations, with the benefit of this disclosure, those of ordinary skill can readily select appropriate molecules to form micelles for use with any of a variety of pollutants desirably taken up.

In some instances, it may be beneficial to shape the micelle-containing polymer compositions into spherical particles, for example, to increase the surface area of the composition. Advantageously, the compositions described herein may be formed into particles (e.g., microparticles), for example, using microfluidic devices and system, as described in more detail below. Hydrophilic monomers, micelles, and, in some cases, crosslinking agent(s) may be dissolved in an aqueous phase and formed into a droplet by flowing through an oil phase. These droplets may be subsequently polymerized (e.g., UV polymerized) to create microparticles (e.g., hydrogel microparticles). Advantageously, these microparticles, may increase the speed of pollutant uptake by increasing the surface area of the micelle-containing composition relative to polymeric compositions of a different shape. Of course, other shapes are possible, and are described in more detail below.

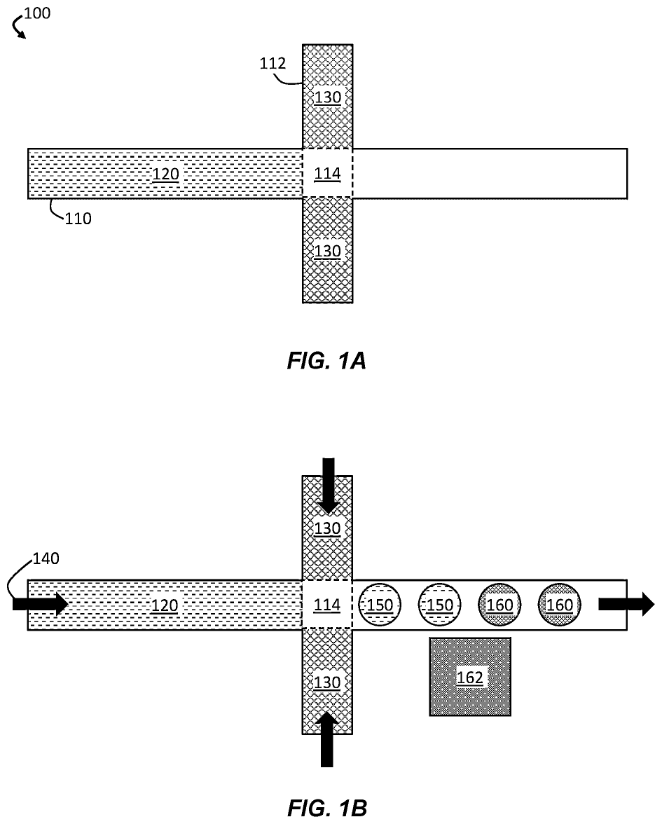

By way of illustration, FIGS. 1A-1B schematically depict a microfluidic system for forming microparticles using the monomeric compositions describes herein. In FIG. 1A, for example, a microfluidic system 100 includes two intersecting channels, a first microfluidic channel 110 and a second microfluidic channel 112, intersecting at an intersection 114. The first microfluidic channel 110 comprises a monomer solution 120 (e.g., an aqueous solution) comprising monomer and micelles (not pictured), while the second microfluidic channel 112 comprises an immiscible fluid 130 (e.g., oil), immiscible with monomer solution 120. Upon commencing flow of the monomer solution and the immiscible solvent, the monomer solution may be formed into a droplet. For example, as illustrated schematically in FIG. 1B, flow 140 is commenced, forming droplets of unpolymerized monomer solution (droplet 150). The droplets can be subsequently polymerized (e.g., photopolymerized) to form microparticles 160 by, for example, exposure to light from a light source 162. More details regarding polymerization are described below and elsewhere herein.

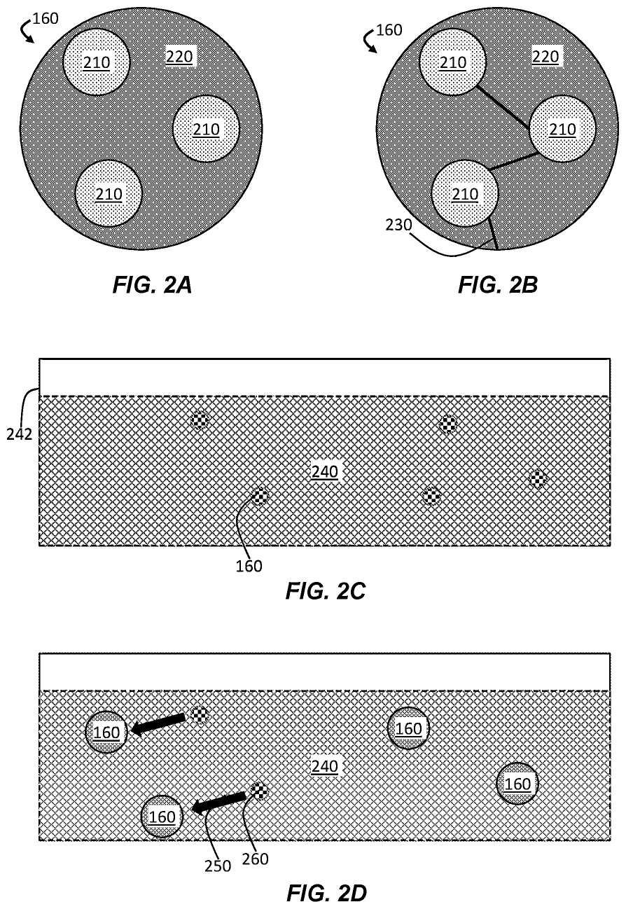

The microparticles may include plurality of micelles. For example, in FIG. 2A, microparticle 160 comprises micelles 210 within a matrix 220. In some embodiments, the micelles and/or the polymeric composition are crosslinked. For example, in FIG. 2B, micelles 210 are crosslinked within the matrix 220 by crosslinking agent 230. However, in other embodiments, no crosslinking agent is present.

The microparticles may be used to remove pollutants (e.g., micropollutants) from a source of water. By way of illustration, FIG. 2C schematically illustrates a plurality of microparticles 160 dispersed in a source of water 240 contained by a container 242. As shown schematically in FIG. 2D, microparticle 160 can absorb (250) a micropollutant 260.

As mentioned above, various embodiments described herein comprise monomer or polymer compositions. For example, a composition may comprise a monomer and a plurality of micelles, wherein each of the micelles of the plurality of micelles comprises a hydrophilic shell and a hydrophobic core. The monomers of the composition can be polymerized to form polymeric compositions containing the plurality of micelles. The compositions may also comprise a crosslinking agent to facilitate polymerization of the monomers and/or formation of polymeric matrix. In some embodiments, the polymerization is a photopolymerization, and the monomer (and/or a crosslinking agent of the composition) comprises a photopolymerizable moiety, which is configured to polymerize at least a portion of the composition upon exposure to light of an appropriate wavelength (e.g., UV light). In some such embodiments, other chemical species may be present to facilitate photopolymerization such as crosslinking agents and/or photoinitiators. Of course, other polymerization techniques are known in the art, and those skilled in the art, in view of the present disclosure, will be capable of selecting an appropriate polymerization technique. Non-limiting examples of other polymerization techniques include click reaction polymerizations, redox-initiated chain growth polymerizations, step polymerizations, and ring-opening polymerizations. Additional details regarding monomeric and polymeric compositions are described in more detail below.

In some embodiments, the articles, compositions, and methods described herein comprise a monomer. As noted above, the monomer may comprise a reactive moiety, such as a photopolymerizable moiety, to facilitate polymerization of the monomer. In some embodiments, the monomer comprises ethylene glycol and/or polyethylene glycol (PEG), such that upon polymerization, the monomer forms a PEG polymer (i.e., a polymer comprising a PEG backbone). In some embodiments, the polymer comprises a hydrophilic moiety, such as PEG, but other hydrophilic moieties are possible. For example, in some embodiments, the monomer comprise a zwitterionic or poly(zwitterionic) species, such as a sulfobetaine (e.g., 2-(methacryloyloxy)ethyl]dimethyl-(3-sulfopropyl)ammonium hydroxide), such that, upon polymerization, the monomer forms a poly(sulfobetaine) polymer (i.e., a polymer comprising a poly(sulfobetaine) backbone). Other non-limiting examples of hydrophilic monomers and/or polymers include carboxybetaine, vinyl sulfone, maleimide, acrylamide, methacrylamide, N-isopropylacrylamide, vinyl alcohol, acrylic acid, methacrylic acid, alginate methacrylate, (2-hydroxyethyl) methacrylate, gelatin methacrylamide, gelatin methacrylate, N,N-dimethyl acrylamide, hyaluronic acid vinyl ester, lactic acid, glycolic acid, and glycidyl methacrylate.

The compositions and articles (e.g., microparticles) described herein include surfactants, or micelles that have been assembled from surfactant molecules. The term “surfactant” is given its ordinary meaning in the art to describe a molecule that lowers the surface tension (or interfacial tension) between two liquids, between a gas and a liquid, or between a liquid and a solid. Surfactant molecules as described herein have a hydrophobic portion and a hydrophilic portion and may self-assemble into “core-shell” micelles in aqueous solution such that the hydrophilic portions of the surfactant molecules are exposed to the aqueous solution on an outer surface of the micelle, while the hydrophobic portions of the surfactant molecules aggregate towards the interior portions of the micelle (to minimize exposure to the surrounding aqueous solution). In some embodiments, the surfactants described herein are functionalized with a reactive moiety (e.g., an acrylate moiety) so that the surfactants can chemically link or otherwise attach to a monomer and/or polymer (e.g., a hydrophilic portion of a monomer and/or polymer). In some embodiments, each micelle of the plurality of micelles comprises a surfactant. In some embodiments, at least one moiety per micelle is chemically linked to the monomer, polymer, and/or the cross-linking agent.

In some embodiments, the micelles are configured to absorb and/or release a hydrophobic molecule. For example, in embodiments where the micelles comprise a hydrophilic shell and a hydrophobic core, the micelle may absorb a hydrophobic molecule towards the hydrophobic core of the micelle (e.g., when the micelles are placed in a source of water containing hydrophobic molecules). However, the micelle may release the absorbed hydrophobic molecule, for example, when the micelles are placed a medium less polar than water (e.g., ethanol). In some embodiments, each of the micelles of the plurality of micelles comprises a hydrophilic shell and a hydrophobic core, and hence each of the micelles of the plurality of micelles may be configured to absorb and/or release a hydrophobic molecule. However, it should be noted that, in other embodiments, only a portion of the micelles of the plurality of micelles is configured to absorb and/or release a hydrophobic molecule. In some such embodiments, a mixture of micelles may be present, where some of the micelles are configured to absorb and/or release a hydrophobic molecule, where some other micelles are not configured to absorb and/or release a hydrophobic molecule.

Various embodiments described herein include one or more crosslinking agents which may facilitate crosslinking of the monomeric and polymeric compositions. Accordingly, some embodiments may further comprise a crosslinking agent comprising a functional moiety configured to link (e.g., covalently bond or non-covalently bond, such as an electrostatic interaction or hydrophobic interaction) the monomer/polymer and/or at least a portion of the plurality of micelles. However, it should be understood that while some embodiments include a crosslinking agent, other embodiments may not include a crosslinking agent and may be polymerized without the presence of a crosslinking agent. Crosslinking is known in the art, and those skilled in the art in view of the teachings of the present disclosure will be capable of determining appropriate crosslinking agents and the degree of crosslinking. In some embodiments, the functional moiety of the crosslinking agent comprises an acrylate moiety (or a derivative thereof). In some embodiments, the crosslinking agent comprises ethylene glycol and/or poly(ethylene glycol). For example, in an exemplary embodiment, the crosslinking agent is poly(ethylene glycol) diacrylate (PEGDA, Mₙ=700 g/mol). Of course, other acrylate-containing crosslinking agents are possible, as this disclosure is not so limited. In some embodiments, the functional moiety comprises an acrylate moiety and/or acrylamide moiety. In some embodiments, the functional moiety of the crosslinking agent comprises an acrylamide moiety, for example, N,N-methylene bisacrylamide. Other crosslinking agents are possible. Non-limiting examples of other crosslinking agents include poly(ethylene glycol) dimethacrylate, poly(ethylene glycol) acrylate methacrylate, ethylene glycol diacrylate, ethylene glycol dimethacrylate, ethylene glycol acrylate methacrylate, poly(ethylene glycol) diacrylamide, ethylene glycol diacrylamide, multi-arm poly(ethylene glycol) acrylate, multi-arm poly(ethylene glycol) acrylamide, multi-arm poly(ethylene glycol) methacrylate, multi-arm poly(ethylene glycol)methyl ether thiol. Other functional group moieties are possible. For example, in some embodiments, the functional moiety comprises Wherein the functional moiety comprises a thiol moiety, a vinyl sulfone moiety, a maleimide moiety, a methacrylate moiety, an acrylamide moiety, a methacrylamide moiety, a vinyl moiety, an amine moiety, a carboxylic acid moiety, an amide moiety, an alcohol moiety, an ester moiety, and/or an imide moiety, without limitation. In some embodiments, the crosslinking agent comprises ethylene glycol and/or N,N-methylene bisacrylamide.

In some embodiments, the monomer and/or the crosslinking agent may be photopolymerized (i.e., polymerized using light/electromagnetic radiation). To facilitate photopolymerization, the crosslinking agent may also comprise a photointiator. One example of suitable photoiniator for the articles and compositions described herein is 2-hydroxy-2-methylpropiophenone. Of course, other photoinitiators are possible. Non-limiting examples of other suitable photoinitiators include lithium phenyl-2,4,6-trimethylbenzoylphosphinate, benzoyl peroxide, and azobisisobutyronitrile, 1-hydroxycyclohexylphenylketone, benzophenone, methylbenzoylformate, oxy-phenylacetic acid, 2-[2 oxo-2-phenylacetoxyethoxy]ethyl ester, 2-[2-hydroxy-ethoxy]ethyl ester, α,α-dimethoxy-α-phenylacetophenone, 2-benzyl-2-(dimethylamino)-1-[4-(4-morpholinyl)phenyl]-1-butanone, 2-methyl-1-[4-(methylthio)phenyl]-2-(4-4-morpholinyl)-1-propanone, diphenyl(2,4,6-trimethylbenzoyl)-phosphine oxide, phenyl-bis(2,4,6-trimethylbenzoyl)phosphine oxide, bis(η-5-2,4-cyclopentadien-1-yl)-bis-[2,6-difluoro-3-(1H-pyrrol-1-yl)phenyl] titanium, Iodonium (4-methylphenyl)[4-(2-methylpropyl)phenyl]-hexafluorophosphate. Other photoinitiators are possible.

As mentioned above and elsewhere herein, the monomer compositions can be polymerized form polymeric compositions. The polymer compositions may have properties similar to the monomer compositions from which they are derived. For example, a monomer comprises a hydrophilic monomer, then the resulting polymer may comprise a hydrophilic backbone (e.g., a PEG backbone). Accordingly, in some embodiments, the polymer comprises a hydrophilic backbone. In some embodiments, the polymer comprises polyethylene glycol. In some embodiments, the polymer comprises a poly(sulfobetaine) polymer. In some embodiments, the polymer is crosslinked (e.g., using a crosslinking agent). However, in some embodiments, no crosslinking agent is present. In some embodiments, the polymeric composition is a hydrogel. In some embodiments, the polymeric composition is in the form of a hydrogel microparticle.

In some embodiments, the polymer compositions comprise hyaluronic acid, alginate, polyacrylamide, polymethacrylamide, polymethylmethacrylate, polymethacrylate, poly(N-isopropylacrylamide), poly(N-isopropylmethacrylamide), polyvinyl alcohol, polyvinyl sulfone, polylactic acid, polyglycolic acid, polycarboxybetaine, polysulfobetaine, a polyester, a polyamide, a polyimide, a polysulfone, a polyurethane, a poly(thioester), a polyacrylate, a polymethacrylate, a polyacrylamide, a polymethacrylamide, and/or poly(2-(methacryloyloxy)ethyl]dimethyl-(3-sulfopropyl)ammonium hydroxide), without limitation.

The polymer compositions described herein may be formed into any suitable shape. In an exemplary embodiment, the composition is in the form of spherical microparticles (e.g., a plurality of microparticles). Advantageously, spherical microparticles may increase the surface area of the polymer composition. However, other shapes are possible. Other suitable shapes for the composition include, but are not limited to, spheres, rods, fibers, helices, and so forth. Mixtures of differently shaped compositions are also possible (e.g., a mixture of spherical and rod particles). In some embodiments, the polymeric compositions may be in the form of a membrane, a slab, and/or a foam.

It is noted that any terms as used herein related to shape, orientation, alignment, and/or geometric relationship and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, alignment, and/or geometric relationship include, but are not limited to terms descriptive of: shape—such as, round, square, circular/circle, rectangular/rectangle, triangular/triangle, cylindrical/cylinder, cone/conical, elliptical/ellipse, (n)polygonal/(n)polygon, U-shaped, line-shaped, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; arrangement—array, row, column, and the like. As one example, a fabricated article that would be described herein as being “square” would not require such an article to have faces or sides that are perfectly planar or linear and that intersect at angles of exactly 900 (indeed, such an article can only exist as a mathematical abstraction), but rather, the shape of such article should be interpreted as approximating a “square,” as defined mathematically, to an extent typically achievable and achieved for the recited technique as would be understood by those skilled in the art or as specifically described.

For embodiments including microparticles, the microparticles may have a particular average diameter. For example, for some embodiments, an average diameter of the plurality of microparticles is greater than or equal to 1 μm and/or less than or equal to 1000 μm. In some embodiments, an average diameter of the plurality of microparticles is greater than or equal to 1 μm, greater than or equal to 5 μm, greater than or equal to 10 μm, greater than or equal to 20 μm, greater than or equal to 50 μm, greater than or equal to 75 μm, greater than or equal to 100 μm, greater than or equal to 250 μm, greater than or equal to 500 am, greater than or equal to 750 am, or greater than or equal to 1000 μm. In some embodiments, an average diameter of the plurality of microparticles is less than or equal to 1 mm, less than or equal to 750 μm, less than or equal to 500 μm, less than or equal to 250 μm, less than or equal to 100 μm, less than or equal to 75 μm, less than or equal to 50 μm, less than or equal to 25 m, less than or equal to 10 μm, less than or equal to 5, or less than or equal to 1 μm. Combinations of the above-referenced ranges are also possible (e.g., greater than or equal to 1 μm and less than or equal to 1000 μm). Other ranges are possible.

In some embodiments, the composition may include particles (e.g., spherical particles). These particles may have similar properties as the microparticles described herein. In some embodiments, the average diameter of a plurality of particles is greater than or equal to 1 mm, greater than or equal to 10 mm, greater than or equal to 25 mm, greater than or equal to 50 mm, greater than or equal to 100 mm, greater than or equal to 250 mm, greater than or equal to 500 mm, greater than or equal to 750 mm, or greater than or equal to 1 cm. In some embodiments, an average diameter of the plurality of particles is less or equal to 1 cm, less than or equal to 750 mm, less than or equal to 500 mm, less than or equal to 250 mm, less than or equal to 100 mm, less than or equal to 50 mm, less than or equal to 25 mm, less than or equal to 10 mm, or less than or equal to 1 mm. Combinations of the above-referenced ranges are also possible (e.g., greater than or equal to 1 mm and less than or equal to 1 cm). Other ranges are possible.

The microparticles may have a particular mass transfer coefficient. For example, in some embodiments, an average mass transfer coefficient of the microparticles configured to absorb and/or release the pollutant is greater than or equal to 0.01 min⁻¹ and/or less than or equal to 2 min⁻¹. In some embodiments, an average mass transfer coefficient of the plurality of microparticles is greater than or equal to 0.01 min⁻¹, greater than or equal to 0.02 min⁻¹, greater than or equal to 0.03 min⁻¹, greater than or equal to 0.05 min⁻¹, greater than or equal to 0.07 min⁻¹, greater than or equal to 0.1 min⁻¹, greater than or equal to 0.2 min⁻¹, greater than or equal to 0.3 min⁻¹, greater than or equal to 0.5 min⁻¹, greater than or equal to 0.7 min⁻¹, greater than or equal to 1 min⁻¹, greater than or equal to 1.3 min⁻¹, greater than or equal to 1.5 min⁻¹, greater than or equal to 1.7 min⁻¹, or greater than or equal to 2 min⁻¹. In some embodiments, an average mass transfer of the plurality of microparticles is less than or equal to 2 min⁻¹, less than or equal to 1.7 min⁻¹, less than or equal to 1.5 min⁻¹, less than or equal to 1.3 min⁻¹, less than or equal to 1 min⁻¹, less than or equal to 0.7 min⁻¹, less than or equal to 0.5 min⁻¹, less than or equal to 0.3 min⁻¹, less than or equal to 0.1 min⁻¹, less than or equal to 0.07 min⁻¹, less than or equal to 0.05 min⁻¹, less than or equal to 0.03 min⁻¹, less than or equal to 0.02 min⁻¹, or less than or equal to 0.01. Combinations of the above-referenced ranges are also possible (e.g., greater than or equal to 0.01 min⁻¹ and less than or equal to 0.2 min⁻¹). Other ranges are possible.

As mentioned above, the compositions and articles described herein may be used to remove pollutants (e.g., micropollutants, hydrophobic pollutants). In some embodiments, a method for removing pollutants from a source of water is also described. Details regarding the method as described below and elsewhere herein.

Some embodiments include exposing a source of water to a plurality of microparticles comprising a polymer and a plurality of micelles linked to the polymer. The source of water may be any suitable water source (e.g., a water source containing pollutants, a water source to be purified). In some embodiments, the source of water is an ocean, a lake, a sea, a pond, a river, an aquifer, a reservoir, an industrial water source, a residential water source, or a sewage treatment system. Of course, other sources of water are possible as this disclosure is not so limited.

The compositions, articles, and methods described herein may be particularly suitable for capturing or removing pollutants from a source of water. For example, some embodiments include capturing pollutants at least partially within the plurality of micelles. In some such embodiments, capturing may comprise absorbing or adsorbing at least a portion of the pollutants. Pollutants may include any chemical species present in a source of water that reduces the purity of the water. For example, in some embodiments, the pollutant is a micropollutant, present in the source of water at a concentration below 1 mM. In some embodiments, the pollutant comprises a hydrophobic molecule. Without wishing to be bound by any particular theory, in embodiments including micelles comprising a hydrophilic shell and a hydrophobic core, the hydrophobic core of the micelles may have a relatively high affinity for hydrophobic molecules (i.e., hydrophobic micropollutants) relative to a surrounding aqueous phase. As a result, the micelles of a composition can be used to remove pollutants (e.g., hydrophobic micropollutants) within the source of water. Non-limiting examples of hydrophobic molecules include oil, grease, fat, and some lubricants. Other hydrophobic micropollutants may include 2-naphthol, bisphenol A, ethinyl estradiol, perfluorooctanoic acid, and 2,4-dichlorophenol, 1,2,3-trichloropropane, 4-nonylphenol, acetochlor, alachlor, benzene, carbofuran, dicrotophos, diuron, ethylene dibromide, fenamiphos, glyphosate, ibuprofen, methyl tert-butyl ether, methomyl, metolachlor, oxamyl, ammonium perchlorate, propoxur, simazine, tebufenozide, trichloroethylene.

It should also be understood that, in addition to capturing pollutants, the articles, compositions, and methods described herein may also describe the recovery or regeneration of the compositions (e.g., microparticles) and/or removal of the micropollutants from the compositions. For example, a plurality of microparticles comprising micelles configured to absorb and release a hydrophobic micropollutants can be suspended in an aqueous environment containing hydrophobic micropollutants. The microparticles may selectively absorb (at least a portion of) the pollutants, and then the microparticle may be subsequently removed from the water. The microparticles (containing absorbed pollutants) can then be exposed to solution or solvent less polar than water (e.g., an alcohol such as ethanol), whereby the pollutants may selectively partition into the non-aqueous solution or solvent. Accordingly, some embodiments may further comprise exposing the microparticles to a solution comprising a water-miscible organic solvent. Examples of water-miscible organic solvents include alcohols (e.g., methanol, ethanol, 1-propanol, 2-propanol (i.e., isopropyl alcohol), 1-butanol, 2-butanol), diemethyl sulfoxide (DMSO), N,N-dimethylformamide (DMF), acetonitrile (MeCN), and/or acetone, without limitation. Some embodiments may further comprise exposing the microparticles to a solution comprising an alcohol, such as ethanol. In some embodiments, after exposing the microparticles to a water-miscible organic solvent, the micropollutants may partition into the organic solvent, and the microparticles (or other articles containing the polymeric micelle-containing material) may be reused to capture more pollutants, or otherwise recycled.

While non-aqueous solvents may be used to regenerate the compositions and microparticles described herein, other regeneration techniques are contemplated. In some embodiments, regenerating the microparticles comprises exposing the microparticles to a change in pH and/or a change in temperature. In some embodiments, the microparticles (e.g., micelles of the microparticles) may have a first configuration for absorbing pollutants and, upon a change in pH and/or temperature, may have a second configuration (different from the first configuration) for releasing the pollutants to the surroundings.

The following examples are intended to illustrate certain embodiments of the present invention, but do not exemplify the full scope of the invention.

### Example 1

The following example describes the preparation of microparticles comprising crosslinked polymers with a hydrophilic backbone and amphiphilic surfactant molecules (comprising hydrophilic and hydrophobic portions), that have been attached to the polymer via the reaction of an acrylate moiety with the polymer.

Micropollutants, which occur at low concentration in the environment, are ubiquitous, hazardous, and difficult to remove from water using current methods. This example introduces hydrogel-based polymeric absorbents containing immobilized micelles for the removal of hydrophobic micropollutants from water. Acrylated surfactants were synthesized and self-assembled into micelles with hydrophobic cores. The acrylate groups enabled the incorporation of micelles into poly(ethylene glycol) diacrylate (PEGDA) hydrogels by free radical polymerization. NMR spectroscopy was used to characterize the crosslinked hydrogels. The hydrogels may be formulated into microparticles using droplet-based microfluidics to speed uptake by increasing surface area. Hydrophobic micropollutants quickly partitioned into the immobilized micelles within these microparticles, with mass transfer coefficients greater than those deter-mined for a commercially available activated carbon, which is frequently used for water purification. Finally, a sustainable and facile method of regenerating spent absorbent is demonstrated.

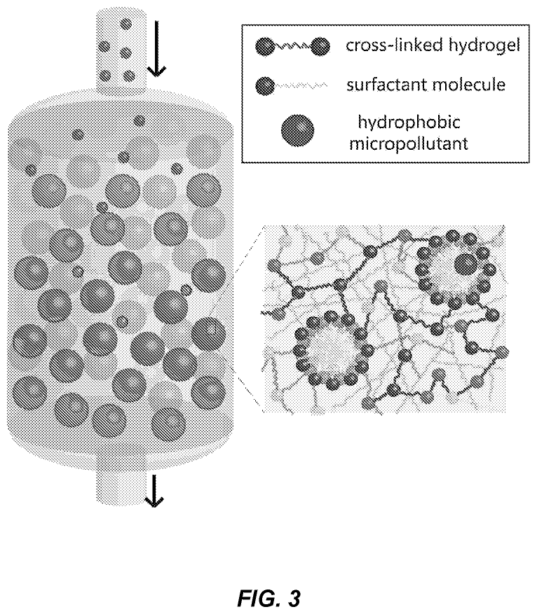

Hydrogel-based absorbents containing immobilized micelles are introduced for the removal of hydrophobic micropollutants, a class of hard-to-remove hazardous emerging contaminants, from water, schematically shown in FIG. 3. Microfluidics is used to synthesize hydrogel microparticles into which micropollutants quickly partition, with faster mass transfer than a commercially available activated carbon frequently used for water purification. A facile method of regenerating spent absorbent is demonstrated.

### Introduction

Water is essential for human life and integral to sustainable economic development. Pollutants may be classified into two categories: macropollutants, and micropollutants. Macropollutants are few in number but contribute to the bulk of water pollution. These macropollutants include coliforms and other microorganisms, runoff from agriculture including phosphates and nitrates, and other organic matter. Micropollutants, on the other hand, are numerous, with each specific component contributing little to total water pollution in terms of mass. Micropollutants include industrial organic solvents, intermediates and lubricants, industrial surfactants, household products such as detergents and disinfectants, antibiotics and other medications, certain heavy metals, food additives and flavoring agents, and nanomaterials.

Though their concentrations are usually low (˜0.01-100 μg/L), micropollutants have been detected to be prevalent in the environment based on the limited measurements that have been conducted. Disconcertingly, many micropollutants can have significant adverse effects on the ecosystem even in low concentrations, which has made them a problem of concern along with conventional macropollutants. Despite increased interest and the pressing need to develop technologies that can remove micropollutants from water, there has been little innovation in terms of new technologies. Since the problem of micropollutants has become apparent only relatively recently, most work on eliminating micropollutants has focused on technologies developed for the elimination of macropollutants, such as activated carbon adsorption, ozone or peroxide oxidation, and photodegradation. Though many pharmaceuticals are effectively removed through biological treatment and photodegradation, the elimination of other micropollutants in wastewater treatment plants remains highly variable and is usually low. Therefore, it is necessary to use multiple techniques sequentially to achieve removal, though even combined treatment strategies fail to eliminate molecules like ciprofloxacin. There are additional, well-known drawbacks to current methods. For instance, it is not environmentally sustainable to make activated carbon, and regeneration requires extremely high temperatures (˜1000° C.). Ozone or peroxide treatment may produce transformation products like chlorates and bromates, which may themselves be hazardous. Another classical technology known to effectively eliminate many pollutants is reverse osmosis, which shows poor elimination of hydrophobic micropollutants. Technologies designed for separating macropollutants are therefore not well-suited for the elimination of micropollutants.

There has been some nascent research into technologies specifically tailored to removing micropollutants from water based on absorbing polymers. There has also been interest in employing nanomaterials for the treatment of water. However, very few technologies have actually translated from the lab to implementation.

Micelles with hydrophilic shells and hydrophobic cores can be used to capture hydrophobic molecules from water. Micelle cores capture hydrophobic molecules into aggregates larger than the molecules themselves. These aggregates can be removed using methods such as ultrafiltration that are easier to implement and more effective than reverse osmosis. Previous studies that attach micelles to much larger clay or magnetic particles evade the extra ultrafiltration step. Here, the synthesis of hydrogel microparticles containing chemically-anchored micelles are reported and their use for water purification is also reported. In contrast with previous work which used surface adsorbents, these particles are bulk absorbents and can therefore be larger and easier to separate from water (since surface area considerations are less important). They also have greater chemical diversity, show faster uptake of pollutants or other species, are significantly easier to produce at scale, and much easier to regenerate.

Though they are large enough to be easily separate them from water, microparticles are sufficiently small to limit the length scales on which transport needs to occur, allowing fast uptake. Microparticles can easily be made using off-the-shelf devices, such as microfluidic devices and systems (e.g., micro-crosses, capillary devices or T-junctions which are built from a few simple parts like tubes and adapters). A micro-cross with an aqueous phase flowing into a continuously flowing oil phase, resulting in droplet formation at the junction by pinch-off was used in this particular example. Such devices are easy to build and scalable and produce monodisperse droplets in a reproducible manner. Hydrogel monomers, micelles, and a photoinitiator are dissolved in the aqueous phase, and the droplets are UV-polymerized to create hydrogel particles.

The partitioning of hydrophobic molecules into the micelle cores within the hydrogels is energetically favorable but does not result in the formation of strong physical or chemical bonds; this allows easy regeneration. Here, a simple regeneration was achieved by washing with 90% ethanol. Ethanol is biosafe at low concentrations, inexpensive and combustible, allowing for safe and economically productive disposal. Hydrophobic micropollutants can be significantly more soluble in ethanol than water; only a small volume of ethanol needs to be used to regenerate the hydrogel absorbents used to clean a large volume of water (1:10³-10⁹).

### Results and Discussion

Micelle-laden hydrogel particles were synthesized from an aqueous solution of monomers containing a crosslinking agent (poly(ethylene glycol) diacrylate (PEGDA), Mₙ=700 g mol⁻¹), a photointiator (2-hydroxy-2-methylpropiophenone (PI)), and a acrylated surfactant (e.g., B25MA=poly(ethylene glycol) behenyl ether methacrylate, Mₙ˜1500 g mol⁻¹; S80TA=Span 80 triacrylate, Mₙ˜591 g mol⁻¹; T80TA=Tween 80 triacrylate, Mₙ˜1472 g mol⁻¹; F127DA=Pluronic F127 diacrylate, Mₙ˜12700 g mol⁻¹). The surfactants were chosen to represent a broad diversity of sizes and structures. B25MA is a polyethoxylated alkane, S80TA is a sorbitan ester, T80TA is a polyethoxylated sorbitan ester, and F127DA is a poloxamer.

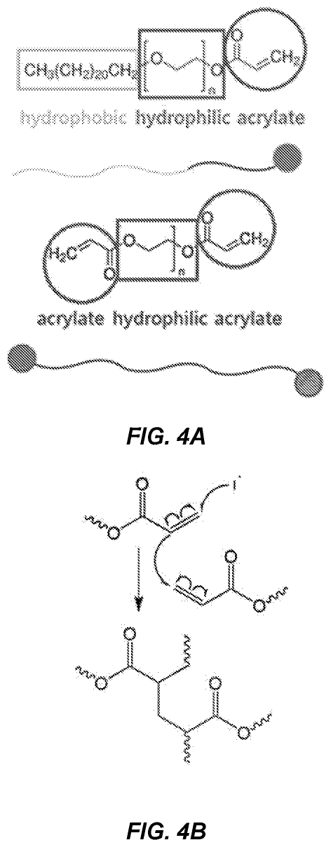

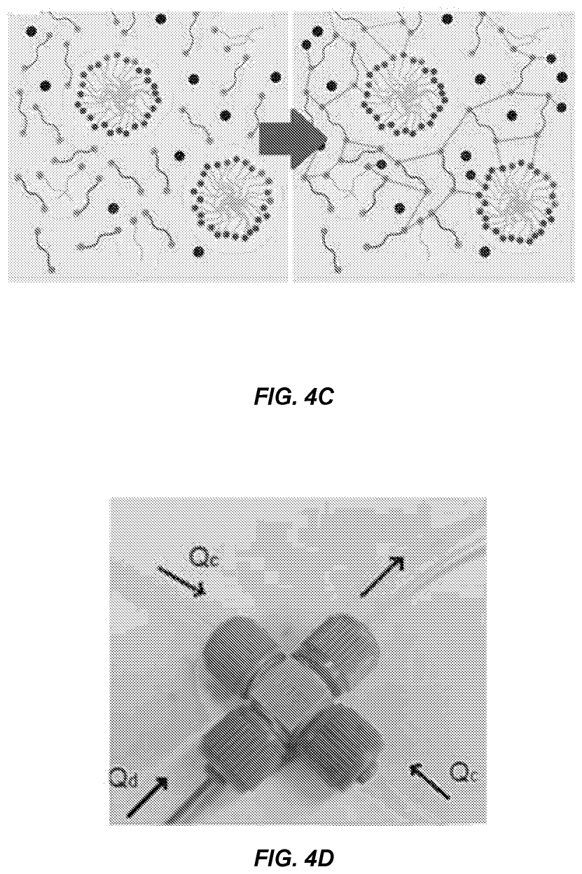

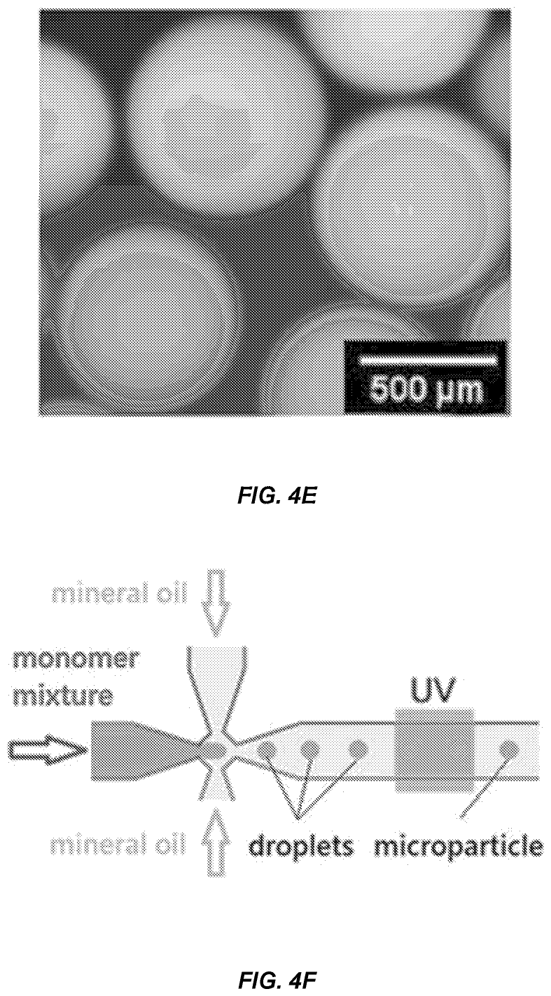

Surfactants may have the form shown in FIG. 4A, with one or more acrylate head groups, one or more hydrophilic blocks, and a hydrophobic block. This is in contrast to PEGDA, which has two acrylate groups and a single hydrophilic section. The acrylate groups enabled the copolymerization of the surfactants with PEGDA, as shown in FIG. 4B. Polymerization is induced by free-radicals generated from the photointiator by exposing the monomer solution to UV light, and results in the formation of the crosslinked bond network FIG. 4B. The surfactants have low critical micelle concentrations (CMCs), and always exceed their CMCs in the monomer solution. The amphiphilic structure of the surfactants causes them to assemble into micelles in the monomer solution and are subsequently incorporated as micelles into the crosslinked hydrogel, illustrated in FIG. 4C.

The aqueous monomer solution were amenable to various forms of processing. An off-the-shelf micro-cross was used (FIG. 4D) to prepare monomer droplets which form due to pinching-off by a mineral oil phase as shown in FIG. 4F. These monomer droplets were then UV-polymerized to make hydrogel microparticles. Flow rates were tuned to make particles ˜500 μm in diameter, irrespective of particle composition. The resultant microparticles were stable in water for long periods of time. FIG. 4E shows a fluorescence microscopy image of monodisperse particles incorporating PEGDA, B25 and rhodamine acrylate made by this method, showing uniform crosslinking.

Crosslinked hydrogels so prepared were then washed over 7 days in water, which is replaced daily, to remove any unreacted monomers and oligomers that are not incorporated into the gel matrix. Extensive washing ensured that no hydrogel leached into the water when used for micropollutant removal and enabled detection and quantification of micropollutants at environmentally relevant concentrations.

### Characterization of Hydrogels

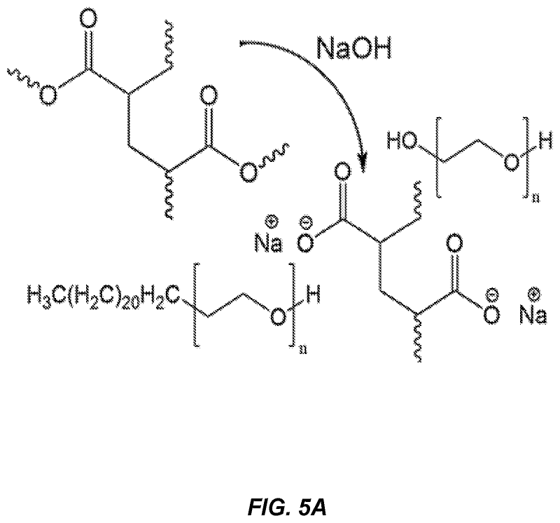

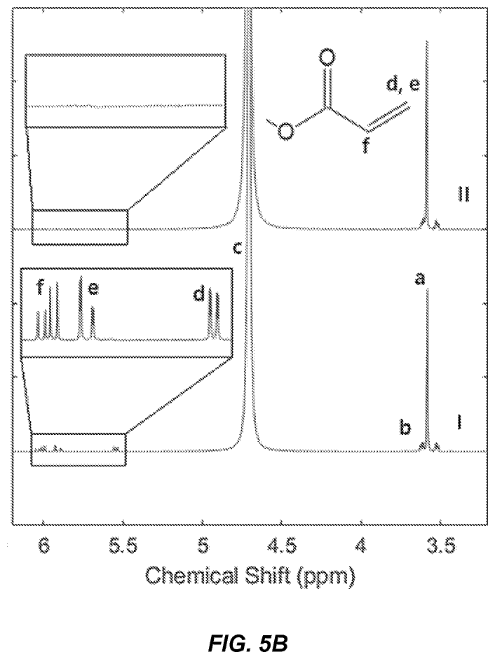

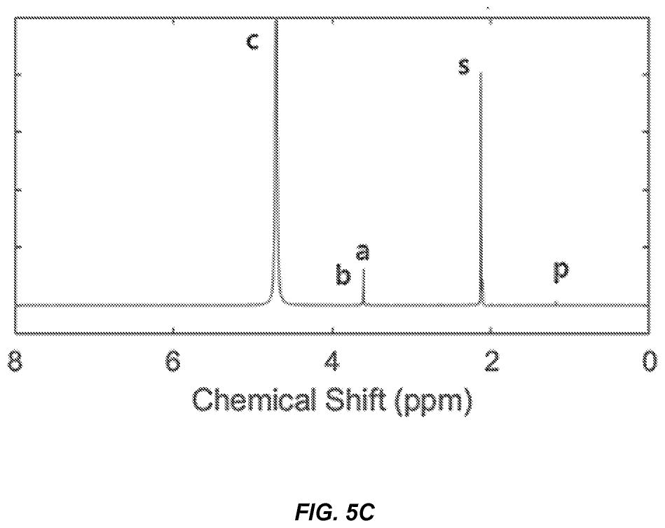

Hydrogels prepared as described above were characterized using H-NMR spectroscopy to study conversion during the polymerization process and assess the extent of leaching during the washing process. The synthesized hydrogels are crosslinked and therefore not soluble in any solvent, which precludes direct H-NMR analysis. Instead, the synthesized gels were hydrolyzed using a strong base, 1M NaOH. Hydrolysis breaks the ester linkages in PEGDA and the surfactants leaving behind a mixture of poly(ethylene glycol) (PEG), unacrylated surfactant, and sodium polyacrylate, all of which are oligomers soluble in water (FIG. 5A). This hydrolysis process did not affect any unreacted double bonds, and can be used to analyze conversion.

FIG. 5B shows H-NMR spectra corresponding to the hydrolyzed monomer solution (I) and the hydrolyzed hydrogel particles (II) for a composition of 10% PEGDA, 5% PI, and no surfactant. Peaks (a,b) correspond to PEG protons, (c) to protons in the solvent (water), and (d,e,f) to acrylate protons. The disappearance of peaks (d,e,f) during the polymerization process indicates near-complete conversion of double bonds. However, not all molecules are incorporated into the gel matrix, with some forming oligomers held within the hydrogel by steric effects. These oligomers are slowly released into water during washing over the course of a week. The concentrations of such oligomers are sufficiently low as not to affect most hydrogel applications; in this study, they were analyzed carefully because they could potentially interfere with the detection of low concentrations of micropollutants.

The amount of PEGDA and PI incorporated into the hydrogel particles can also be determined using H-NMR analysis. FIG. 5C shows the H-NMR spectrum corresponding to particles which were hydrolyzed after washing for 7 days to remove any unincorporated oligomers. Peaks (a,b,c) are as described above, and peak (p) corresponds to the photoinitiator (PI). Peak (s) corresponds to acetone, a precise amount of which is added as an internal standard. An internal standard is essential to benchmark the decrease in the area of peaks (a,b,p) compared to the original mixture (FIG. 5B), while correcting for any measurement linked variation that may have occurred. Acetone was used as an internal standard because it is miscible with the hydrolyzed mixture, because it produces only one sharp peak in H-NMR spectra, and because that peak is well-separated from other peaks of interest. Since the concentration of acetone is known, the area under the acetone peak can be used to determine the concentrations of PEGDA and photoinitiator. These are found to be lower than the concentrations in the unwashed particles (FIG. 5B), and the difference corresponds to the loss of PEGDA and PI during the washing process, in the form of unincorporated oligomers. The difference was determined to be 18.8% of the initial amount of PEGDA, and 62.1% of the initial quantity of PI, for a composition of 10% PEGDA, 5% PI, and no surfactant. The amount of photointiator loss is much larger because the PI is in significant molar excess (molar ratio 4.43:1) to ensure fast polymerization, and because smaller oligomers have a greater molar fraction of PI than PEGDA.

### Equilibrium Uptake and Regeneration

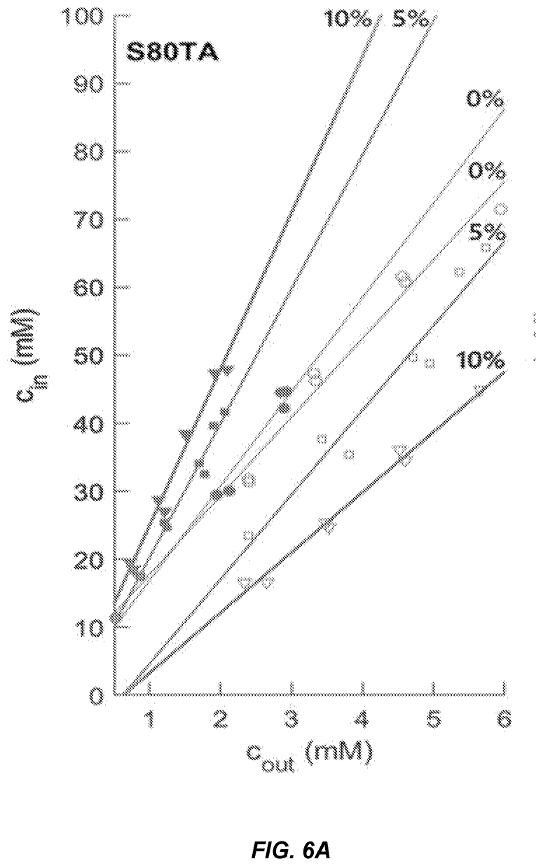

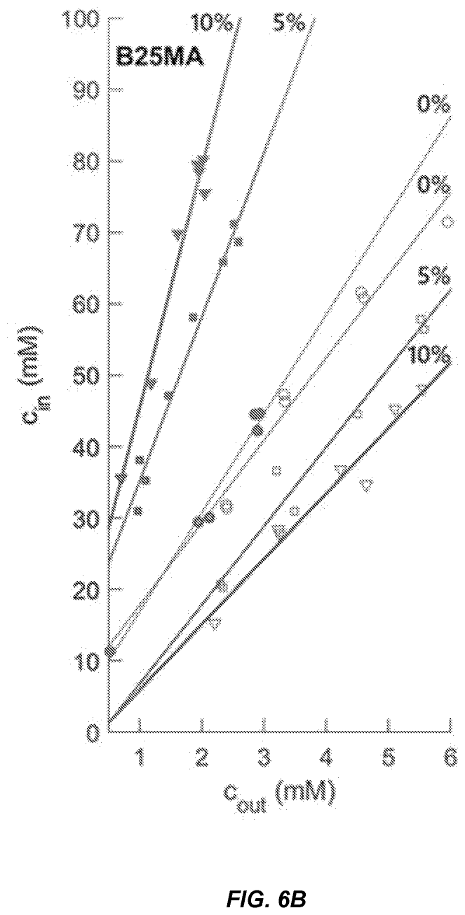

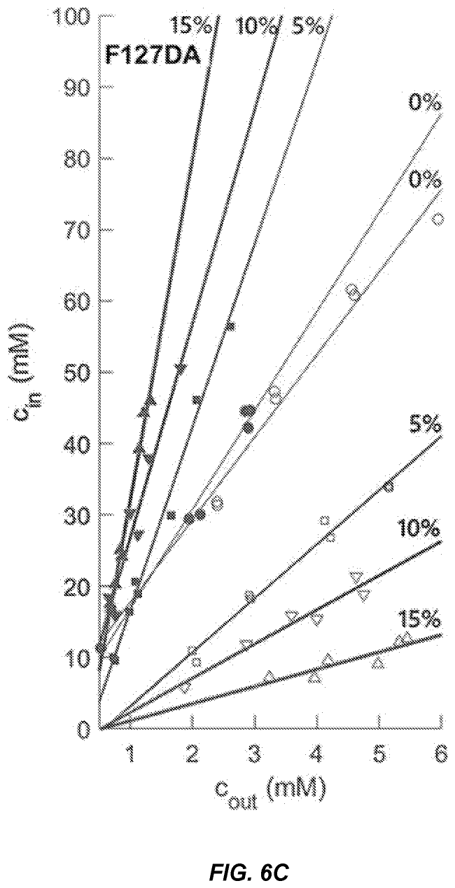

Hydrogels were prepared using a monomer solution with a fixed amount of crosslinking agent (10% PEGDA) and photointiator (5% PT), but with a varying amount of surfactant to assess effects on micropollutant uptake. The amount of surfactant is limited by solubility for B25MA, S80TA and T80TA, but by the formation of a gel for F127DA. 2-Naphthol is used as a canonical hydrophobic micropollutant in this example, 2-Naphthol has been used in other work as a model micropollutant and is itself an organic pollutant of concern, known to be difficult to remove using conventional methods. Varying quantities of 2-naphthol were dissolved in two solvents, water and 90% ethanol, and a known amount of hydrogel was added to each sample and mixed for 24 hours in the dark. The initial concentration of 2-naphthol was low, and in the range relevant to water purification. The concentration of 2-naphthol in the supernatant was measured at equilibrium using absorbance spectroscopy, and a mass balance was used to determine the concentration inside the hydrogel microparticles. These data were then used to produce the equilibrium isotherms shown in FIG. 6.

Straight lines can be seen to fit the data well. The parameter of interest was the slope of the equilibrium isotherms, called the partition coefficient, defined here as the ratio of the concentration of 2-naphthol inside the particles to the concentration in the supernatant at equilibrium. The partition coefficient was greater than 1 for all systems, indicating that hydrophobic micropollutants always preferentially partition into the hydrogel microparticles. This partitioning was a combination of two effects: the physical separation of pollutant molecules into hydrophobic micelle cores, and the formation of hydrogen bonds between the pollutant molecules and ethylene oxide units in the hydrogel matrix. The first effect was weakly dependent on the supernatant and was responsible for preferential partitioning in surfactant-free hydrogel microparticles. The second, micelle-mediated effect, was strongly dependent on the supernatant; hydrophobic molecules prefer micelle cores to water, but this preference is much lower when the supernatant is itself more hydrophobic.

It was therefore observed that the partition coefficient when water was the supernatant increases upon increasing the amount of surfactant in the hydrogel; the increase is attributed to the increased number of micelles in the hydrogel, increasing its carrying capacity. The introduction of micelles disrupts hydrogen bonding in the hydrogel, but the micelle-mediated effects dominate when water is the solvent. F127DA has higher partition coefficients than S80TA and B25MA, corresponding to the larger size of the hydrophobic zone in those molecules.

On the other hand, the micelle-mediated effect is weaker and does not dominate when the supernatant is 90% ethanol, which has greater affinity for hydrophobic molecules than water. The disruption of hydrogen bond formation due to the introduction of micelles is now the dominant effect, and the partition coefficient decreased with an increase in surfactant concentration.

The partition coefficient was larger when water is the supernatant compared to ethanol, and this difference is leveraged to regenerate spent absorbent. Hydrogel microparticles were used to clean contaminated water, and pollutant can be recovered from microparticles by washing with a smaller volume of 90% ethanol. 90% ethanol was used because it is sufficiently hydrophobic, relatively inexpensive (being lower in concentration than the ethanol-water azeotrope), biocompatible in trace amounts (if it enters the water stream through regenerated particles), and flammable (so it can be used as a fuel or fuel-additive, destroying any pollutant molecules during combustion).

### Kinetics of Water Purification

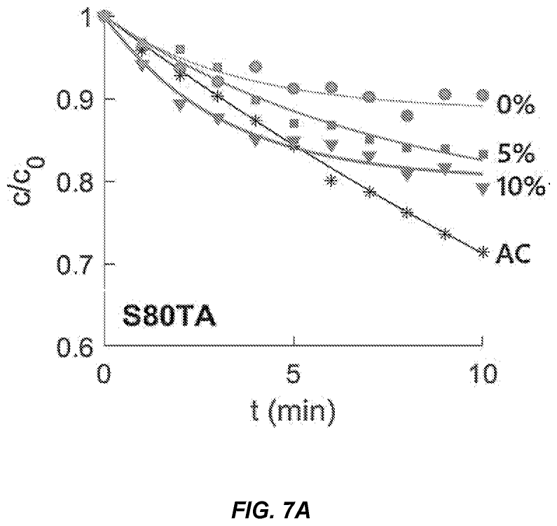

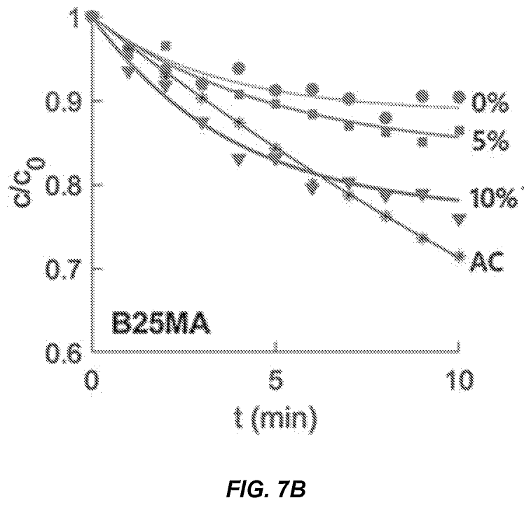

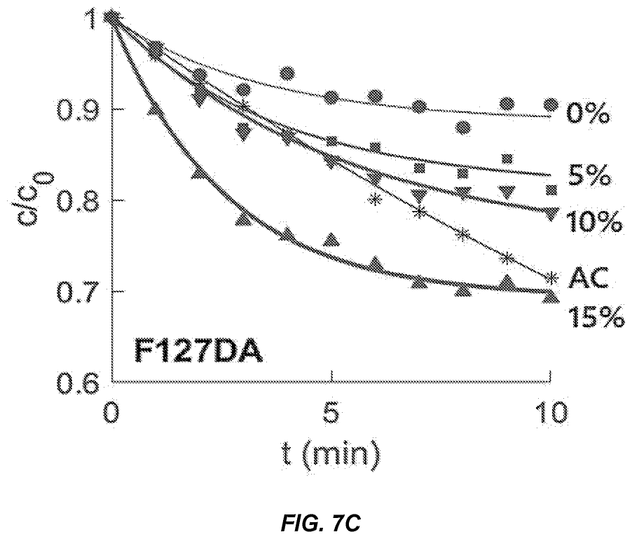

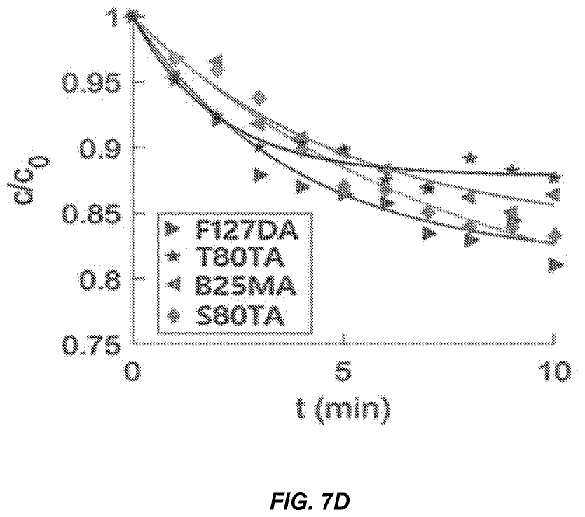

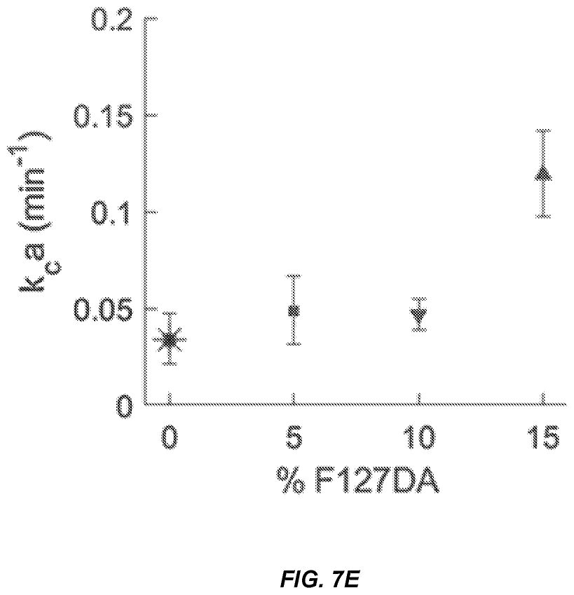

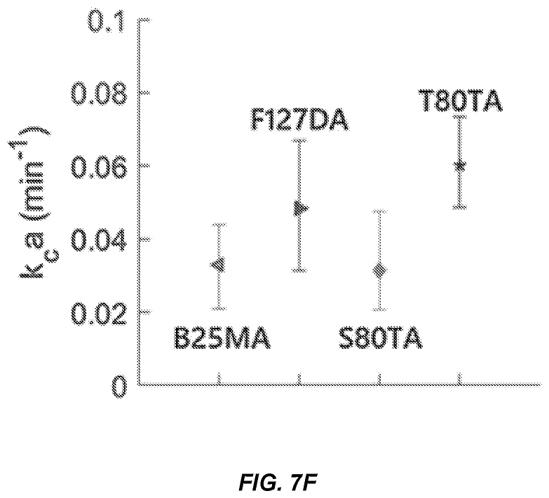

The rate of pollutant removal is as important as the equilibrium capacity of the absorbent in water purification applications. Hydrogel microparticles (500±75 μm) were prepared using a monomer solution with 10% PEGDA, 5% PI and varying surfactant fractions. The microparticles were added to a well-mixed bath containing 100 times their volume of 5 mM 2-naphthol and absorbance spectroscopy was used to track the concentration of 2-naphthol in the supernatant over time, which is shown in FIG. 7.

FIGS. 7A, 7B and 7C show the decrease in 2-naphthol concentration in the supernatant over time, which corresponded to the uptake of pollutant molecules by the hydrogel microparticles in the bath. The decrease was exponential and increasing the surfactant fraction in the microparticles increases the speed and extent of pollutant removal. All micelle-laden hydrogels performed better than hydrogels without surfactants (shown using filled circles). The performance of these materials was compared to an equal weight of commercial activated carbon sold to clean drinking water (Brita® AC, in black asterisks). One of the formulations shown here, with 15% F127DA, can be seen to outperform an equal mass of activated carbon in terms of total pollutant removed on the short time scales that are more relevant to water purification, where contact times are typically on the order of minutes. FIG. 7D indicates that there was slight variation across surfactants at the same concentration, with F127DA-containing particles showing the improved performance.

The data in FIGS. 7A, 7B, 7C, and 7D fit equation 1. Here, V is the bath volume, Vₚ is the absorbent/adsorbent volume, K is the partition coefficient defined above, K_{ca} is the mass transfer coefficient.

$$\frac{c ( t )}{{c}_{0}} = \frac{\frac{V}{{V}_{p} K} + {e}^{- ( 1 + \frac{V}{{V}_{p} K} ) {k}_{c} at}}{1 + \frac{V}{{V}_{p} K}}$$

The mass transfer coefficient was the parameter of interest in water purification studies, because it limited the maximum water flowrate through the absorbent bed. The mass transfer coefficient increases with increase in surfactant present within the hydrogel (FIG. 7E) and was larger than the mass transfer coefficients corresponding to surfactant-free hydrogels and activated carbon. F127DA and T80TA-containing hydrogels had a higher mass transfer coefficient than B25MA and S80TA-containing hydrogels; this corresponded to the larger hydrophobic groups in F127DA and T80TA compared to B25MA and S80TA.

### Nonaqueous Solvents to Increase Surfactant Load

The extent and speed of pollutant uptake increases with surfactant concentration, which was limited by solubility for B25MA, S80TA, and T80TA and by the formation of a gel for F127DA. Gelation precluded the use of a micro-cross to prepare droplets and also prevents polymerization due to the high viscosity of the sample. With 10% PEGDA and 5% PI, the concentration of F127DA cannot exceed 15% in the aqueous monomer solution without forming a gel. However, gel formation could be inhibited by dissolving the monomers in a mixture of water and ethanol. Phase equilibria in similar systems have been studied previously, and it was known that 30% or higher ethanol amounts allow the dissolution of greater amounts of F127 without gelation. At the same time, ethanol concentrations cannot exceed 50%, because this reduced the surface tension of the monomer solution to the extent that stable droplet formation was not easily achievable.

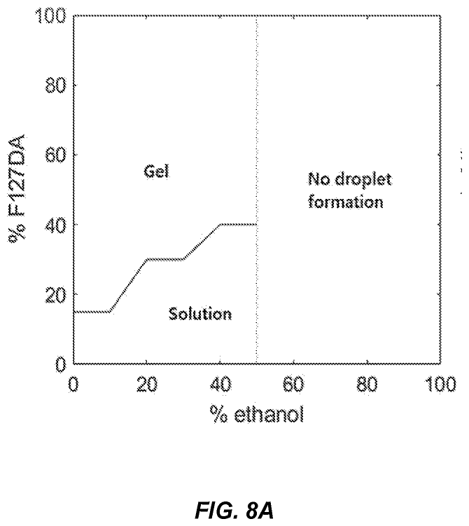

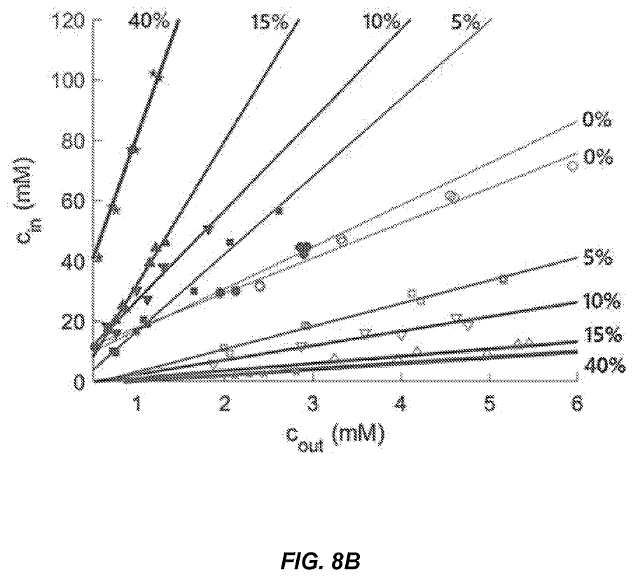

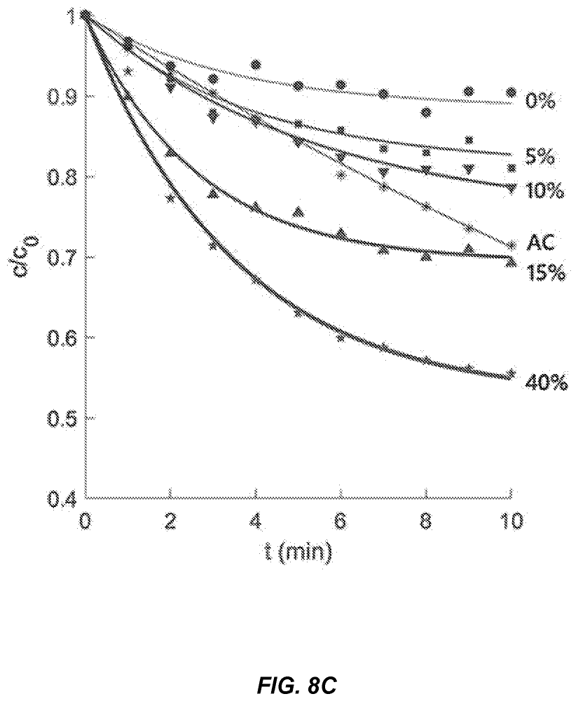

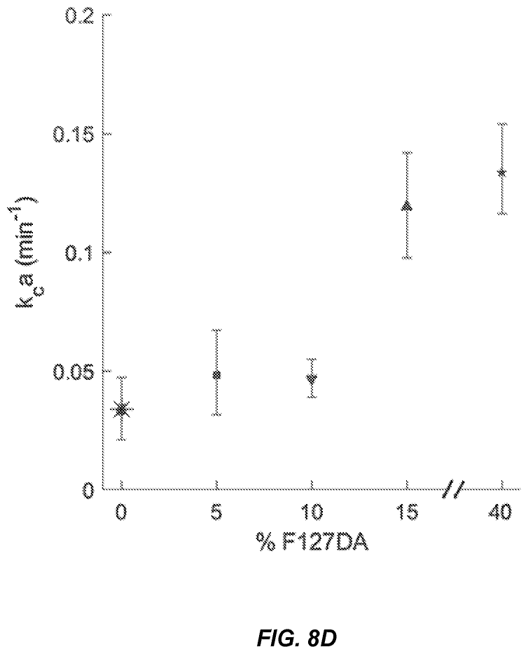

FIG. 8A shows a phase diagram corresponding to a monomer solution with 10% PEGDA, 5% PI and varying concentrations of F127DA dissolved in water-ethanol mixtures with varying ethanol fraction. The maximum F127DA concentration which can be achieved without gelation is 40%, when 40% of the solvent was ethanol. The presence of ethanol did not affect the uptake capacity of the microparticles significantly, and microparticles made from 10% PEGDA, 5% PI and 40% F127DA in 60% water and 40% ethanol showed the fastest and greatest pollutant uptake.

The equilibrium isotherm corresponding to the 40% F127DA/40% ethanol system are shown in FIG. 8B. As before, the increase in surfactant load increased the water partition coefficient (to nearly double that of 15% F127DA particles) and reduced the ethanol partition coefficient. The speed and extent of uptake (FIG. 8C) are also improved, due to an increase in the mass transfer coefficient (FIG. 8D). The total pollutant removed was twice the amount removed by activated carbon in 5 minutes, and 40% F127DA particles achieved the same amount of pollutant as an equal mass of activated carbon with a contact time of 10 minutes in only 3 minutes. The mass transfer coefficient was 4 times the commercial activated carbon. Note that the increase in mass transfer coefficient decreased with increasing F127DA loading. Without wishing to be bound by theory, this was a result of two competing effects: (i) greater number of micelles, which increased mass transfer, and (ii) denser (and less porous) particles, which lowered mass transfer.

### Conclusion

The use of micelle-laden hydrogels for the removal of hydrophobic micropollutants was demonstrated. A model hydrophobic micropollutant, 2-naphthol, was used, but the approach extends to the removal of any hydrophobic micropollutant and other micropollutants since it is not dependent on the formation of specific chemical bonds. Both the speed and extent of pollutant removal increased with the amount of surfactant incorporated into the hydrogels, and surfactants with larger hydrophobic segments are more effective in removing pollutant molecules. Preparing microparticles using the hydrogels reduced the length scale of pollutant transport, and the materials studied in this example have higher mass transfer coefficients than commercial activated carbon. The production of microparticles is easy to scale up. Finally, it was demonstrated that the presence of micelles allowed spent absorbent to be regenerated, and the extent to which regeneration is possible increased with increases in the amount of incorporated surfactant. Micelle-laden hydrogel microparticles are therefore a promising material for the elimination of hard-to-remove hydrophobic micropollutants (and other pollutants) from water.

### Example 2

The following example describes the synthesis and characterization of acrylated surfactants.

### Experimental Section

Materials: All chemicals used in the examples were purchased from Sigma-Aldrich and used as received. Materials used in hydrogel synthesis include PEGDA, PI (photoinitiator), and surfactants. B25MA was purchased from Sigma-Aldrich while S80TA, T80TA and F127DA are synthesized from unacrylated precursors which were commercially available. Acryloyl chloride, dichloromethane (DCM), and sodium bicarbonate were used in the acrylation process, and 2-naphthol was used in uptake studies. Ethanol, used for regeneration, is purchased at 99.9% purity and diluted to 90%.

Synthesis of acrylated surfactants: Unacrylated precursors S80, T80 and F127 terminate in alcohol groups. Acrylate groups were attached as follows. Surfactants were dissolved in DCM (120 ml) and a 20% molar excess of sodium bicarbonate was added. The same molar excess of acryloyl chloride was dissolved in DCM (20 ml), and the solution was added to the reaction mixture drop-wise over 60 minutes with constant stirring. The reaction was then allowed to proceed with continuous stirring, in the dark for 48 hours. The mixture was then filtered using a Buchner funnel to remove solids and the solvent was removed under vacuum at 30° C. H-NMR spectroscopy was used to confirm acrylation and calculate conversion (>90% in all cases).

H-NMR spectroscopy: The H-NMR spectra were obtained using a three-channel Bruker Avance Neo spectrometer operating at 500.34 MHz. The system was equipped with a 5 mm liquid-nitrogen cooled Prodigy broad band observe (BBO) cryoprobe. Data was collected with 16 scans per sample.

UV/Vis absorbance spectroscopy: 2-Naphthol was detected using UV/Vis absorbance spectroscopy using a spectrophotometer. Peaks in the spectrum at 273 nm and 326 nm were used to prepare a calibration based on the Beer-Lambert law, and accurate detection of micromolar concentrations was possible.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition, comprising:
a monomer; and
a plurality of micelles, wherein each micelle of the plurality of micelles comprises a hydrophilic shell and a hydrophobic core;
wherein the micelles are configured to absorb and/or release a hydrophobic molecule.

2. The composition of claim 1, further comprising a crosslinking agent comprising a functional moiety configured to link the monomer and at least a portion of the plurality of micelles.

3. The composition of claim 1, wherein the monomer comprises ethylene glycol or poly(ethylene glycol).

4. The composition of claim 1, wherein the monomer comprises 2-(methacryloyloxy)ethyl]dimethyl-(3-sulfopropyl)ammonium hydroxide.

5. The composition of claim 1, wherein each micelle of the plurality of micelles comprises a surfactant.

6. The composition of claim 2, wherein the crosslinking agent comprises ethylene glycol and/or N,N-methylene bisacrylamide.

7. The composition of claim 2, wherein the functional moiety comprises an acrylate moiety and/or acrylamide moiety.

8. The composition of claim 1, wherein at least one moiety per micelle is chemically linked to the monomer and/or the cross-linking agent and the micelle.

9. A plurality of particles, each particle comprising:
a polymer; and
a plurality of micelles linked to the polymer,
wherein at least a portion of the particles is configured to absorb and/or release a pollutant.

10. The plurality of particles of claim 9, wherein each microparticle comprises a hydrogel.

11. The plurality of particles of claim 9, wherein the polymer comprises a hydrophilic backbone.

12. The plurality of particles of claim 9, wherein the polymer comprises polyethylene glycol.

13. The plurality of particles of claim 9, wherein the polymer is crosslinked.

14. The plurality of particles of claim 9, wherein each of the micelles comprises a hydrophilic shell and a hydrophobic core.

15. The plurality of particles of claim 9, wherein each micelle comprises a surfactant.

16. The plurality of particles of claim 9, further comprising a crosslinking agent.

17. The plurality of particles of claim 9, wherein an average diameter of the plurality of particles is greater than or equal to 1 μm and/or less than or equal to 1000 μm.

18. The plurality of particles of claim 9, wherein an average mass transfer coefficient of the particles configured to absorb and/or release the pollutant is greater than or equal to 0.01 min⁻¹ and/or less than or equal to 2 min⁻¹.

19. A method for removing pollutants from a source of water, the method comprising:
exposing the source of water to a plurality of microparticles comprising a polymer and a plurality of micelles linked to the polymer, wherein each of the micelles of the plurality of micelles comprises a hydrophilic shell and a hydrophobic core;
capturing pollutants at least partially within the plurality of micelles; and
removing the microparticles from the source of water.

20-24. (canceled)
